(19) United States
(12) Patent Application Publication
(10) Pub. No.: US 2011/0114639 A1
(43) Pub. Date: May 19, 2011

(54) ROTOR FOR A LOCK, AND ASSOCIATED LOCK

(75) Inventors: Philippe Garcin, Creteil Cedex (FR); Philippe Reiner, Creteil Cedex (FR)

(73) Assignee: VALEO SECURITE HABITACLE, Creteil Cedex (FR)

(21) Appl. No.: 12/746,860

(22) PCT Filed: Dec. 4, 2008
(86) PCT No.: PCT/EP08/66810

§ 371 Date: Jan. 31, 2011

(30) Foreign Application Priority Data
Dec. 11, 2007 (FR) 0708593

(51) Int. Cl. B65D 41/04; E05C 19/00

(52) U.S. Cl. 220/288; 292/2

(57) ABSTRACT

The invention relates to a rotor (7) intended to be fastened in a lock stator by immobilizing means. According to the invention, the means for immobilizing the rotor (7) comprise a latch (11) having an elastically deformable protuberance (13) which is capable of engaging with an associated chamfered region (15) of the rotor (7) in order to immobilize said rotor in a mounting position.

The invention relates to a rotor, particularly for a motor vehicle lock, which is fixed with respect to the lock stator by rotor immobilizing means.

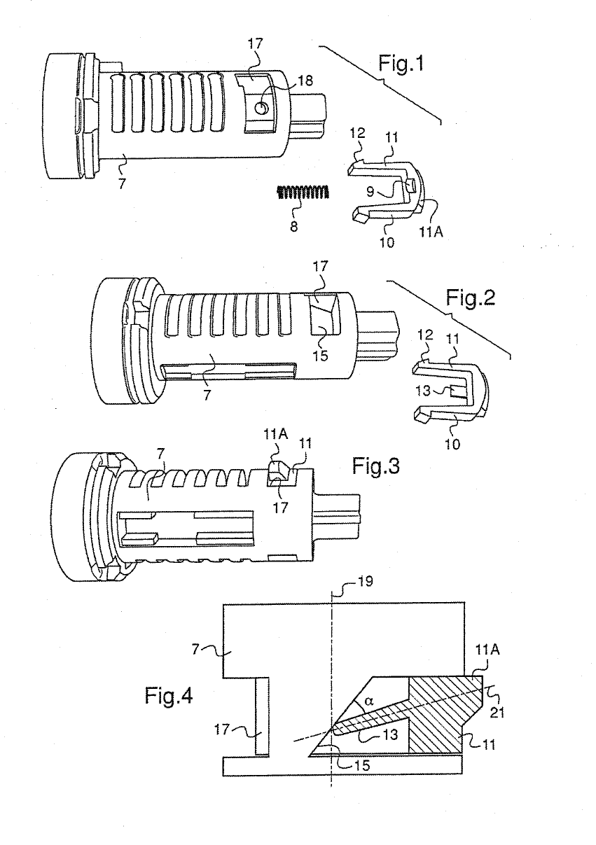

Conventionally, as illustrated in FIG. 1, means of immobilizing the rotor 7 which are in the form of a moving bolt 11 and of an associated spring 8 are known.

According to one known embodiment, the bolt 11 is substantially U-shaped comprising two lateral branches 10 ending in fixing elements 12 to clip onto the rotor 7, and a projection-forming base 11A which has a substantially rounded external edge able to engage in a corresponding housing belonging to a stator.

The helical spring 8 is partially housed in a recess 9 of the bolt 11 at the internal edge of the projecting element 11A. The housing 17 of the rotor comprises a recess 18 that complements the free end of the spring 8. The spring 8 rests, firstly, against the bolt 11 and, secondly, against the rotor 7. The spring 8 thus exerts a return force on the bolt 11 returning it toward the position in which the projecting element 11A is engaged in the corresponding housing in the stator.

However, when the rotors are being assembled, positioning the spring and the bolt proves to be a tricky and lengthy operation.

The invention therefore sets out to propose immobilizing means that reduce the time taken to assemble the rotor.

A further object of the invention is to provide a rotor intended to be fixed into a lock stator by immobilizing means, characterized in that the rotor immobilizing means comprise a bolt comprising an elastically deformable protrusion which is able to collaborate with an associated chamfered zone of the rotor to immobilize the latter in the mounting position.

Another advantage of the present invention is that the number of loose parts along the edge of the assembly line is minimized, as is the number of operations, to the benefit of production line assembly times.

For preference, the protrusion is integrally formed.

According to one advantageous embodiment, the bolt is substantially U-shaped having a base and two branches ending in fixing elements for fixing to the rotor.

Another objective of the invention is to provide a rotor which comprises a housing to accommodate said bolt, such that said protrusion pushes said bolt back radially toward the outside of this housing, toward a position in which said bolt projects from this housing.

In this case, the bolt has, toward the outside of its housing, a face that collaborates with a corresponding housing of the stator.

Advantageously, the chamfered zone forms a plane of contact that is inclined with respect to the axis of the rotor, and the protrusion has an axis that forms a non-zero acute angle with this plane of contact.

For preference, the bolt is made of plastic.

The invention also relates to a lock particularly for a motor vehicle, comprising the stator able to accept a rotor according to the invention as specified hereinabove.

The invention also relates to a fuel filler cap intended to be fixed to the external end of a vehicle fuel tank filling pipe to close off said pipe, which comprises a stator-forming housing able to accept a rotor according to the invention.

Other features and advantages of the invention will become more clearly apparent from reading the following description of a preferred embodiment given by way of simple nonlimiting illustrative example and from studying the attached drawings among which:

FIG. 1 depicts an exploded view of a rotor and its immobilizing means according to the prior art;

FIG. 2 depicts an exploded view of a rotor and its immobilizing means according to the invention;

FIG. 3 illustrates a rotor and its immobilizing means mounted according to the invention;

FIG. 4 is a diagram depicting the immobilizing means mounted on the rotor.

FIG. 1 was already described earlier in the introduction to the prior art.

In the remainder of the description, elements that are identical or similar to those previously described are denoted by the same references.

According to the invention, the bolt 11 and the elastic means are produced as a single piece. As may be seen from FIG. 2, the bolt 11 has an elastically deformable protrusion 13 which is able to collaborate with an associated chamfered zone 15 of the rotor 7 to immobilize the latter in the mounting position, the protrusion 13 being integrally formed at the axis of symmetry of the bolt 11. Of course, the protrusion 13 could equally well be an element clipped onto the bolt 11.

According to the embodiment described, the bolt 11 is substantially U-shaped comprising a base 11A and two lateral branches 10 ending in fixing elements 12 able to clip to the rotor 7.

The bolt 11 is mounted in a housing 17 of the rotor 7 so that it is capable of translational movement along an axis perpendicular to the axis of the rotor 7 inside the housing 17 between a position in which the bolt 11 is flush with the housing 17 and a position in which the bolt 11 projects from this housing 17, under the action of the protrusion 13.

With reference to FIG. 3, the base 11A of the bolt 11 is substantially in the shape of a circular arc, projects and is able to engage in an associated housing belonging to the stator, at the time of assembly.

As illustrated in FIG. 4, the chamfered zone 15 forms a plane of contact that is inclined with respect to the axis 19 of the rotor 7. The protrusion 13 follows an axis 21 which therefore makes a non-zero acute angle α with this plane of contact. The magnitude of this angle α determines whether the face 11A of the bolt 11 is positioned projecting from or flush with the housing 17 of the rotor 7. In the projecting position, the bolt 11 immobilizes the rotor 7 in the mounting position.

For preference, the bolt 11 is made of plastic.

Thus, assembling the rotor in the stator according to the invention entails a first operation of clipping the bolt 11 into the housing 17 in the rotor 7, and a second operation of introducing the rotor 7 associated with the bolt 11 into the stator 5. The bolt 11 thus immobilizes the rotor 7 and makes for easier mounting.

It is quite obvious that such a rotor according to the invention can be mounted in any lock comprising a stator in which the rotor is fixed.

According to one particular embodiment, such a rotor may be fixed in a stator-forming housing provided in a fuel filler cap intended to be fixed on the external end of a vehicle fuel tank filler pipe in order to close off said pipe.

The element intended to be equipped with a stator or with a stator-forming housing in which a rotor according to the invention is fixed can be varied without departing from the scope of the invention.

1. A rotor intended to be fixed into a lock stator by immobilizing means, wherein the rotor immobilizing means comprise a bolt comprising an elastically deformable protrusion which is able to collaborate with an associated chamfered zone of the rotor to immobilize the rotor in a mounting position.

2. The rotor as claimed in claim 1, wherein said protrusion is integrally formed.

3. The rotor as claimed in claim 1, wherein the bolt is substantially U-shaped having a base and two branches ending in fixing elements for fixing to the rotor.

4. The rotor as claimed in claim 1, further comprising a housing to accommodate said bolt, such that said protrusion pushes said bolt back radially toward the outside of the housing, toward a position in which said bolt projects from the housing.

5. The rotor as claimed in claim 4, wherein said bolt comprises, toward the outside of the housing, a face that collaborates with a corresponding housing of said stator.

6. The rotor as claimed in claim 1, wherein said chamfered zone forms a plane of contact that is inclined with respect to the axis of the rotor, and wherein said protrusion has an axis that forms a non-zero acute angle (α) with the plane of contact.

7. The rotor as claimed in claim 1, wherein said bolt is made of plastic.

8. A lock for a motor vehicle, comprising:
a stator and a rotor fixed in the stator by immobilizing means, wherein the rotor immobilizing means comprise a bolt comprising an elastically deformable protrusion which is able to collaborate with an associated chamfered zone of the rotor to immobilize the rotor in a mounting position.

9. A fuel filler cap intended to be fixed to the external end of a vehicle fuel tank filling pipe to close off said pipe, comprising:
a stator-forming housing and a rotor fixed into the stator-forming housing by immobilizing means, wherein the rotor immobilizing means comprise a bolt comprising an elastically deformable protrusion which is able to collaborate with an associated chamfered zone of the rotor to immobilize the rotor in a mounting position.
